(19) United States
(12) Patent Application Publication
(10) Pub. No.: US 2011/0037271 A1
(43) Pub. Date: Feb. 17, 2011

(54) WIND TURBINE SYSTEM AND MODULAR WIND TURBINE UNIT THEREFOR

(75) Inventor: Yehoshua Sheinman, RaAnana (IL)

Correspondence Address: MARTIN D. MOYNIHAN d/b/a PRTSI, INC., P.O. BOX 16446, ARLINGTON, VA, 22215, US

(73) Assignee: Coriolis-Wind Inc, Wilmington, DE (US)

(21) Appl. No.: 12/988,327

(22) PCT Filed: Apr. 20, 2009
(86) PCT No.: PCT/IL09/00428

§ 371 Date: Oct. 18, 2010

Related U.S. Application Data
(60) Provisional application No. 61/071,287, filed on Apr. 21, 2008.

(51) Int. Cl. F03D 9/00; F03D 3/02; F03D 11/04

(52) U.S. Cl. 290/55; 416/200 R; 416/244 R; 416/176; 416/85

(57) ABSTRACT

A wind turbine system includes a two-dimensional array of a plurality of modular wind turbine units arranged in a plurality of horizontal rows and vertical columns. The two-dimensional array of modular wind turbine units are carried by a frame structure including a plurality of parallel beams extending along a first orthogonal axis and spaced from each other along a second orthogonal axis, with the plurality of modular wind turbine units mounted between each pair of the parallel beams extending along the first orthogonal axis. Also described is a modular wind turbine unit particularly useful in such a system.

### FIELD AND BACKGROUND OF THE INVENTION

The present invention relates to a wind turbine system of modular construction for harvesting wind energy for the generation of electrical energy, or for other purposes. The present invention also relates to a modular wind turbine unit particularly useful in such a system.

Wind turbine systems are gaining larger market shares in the global electricity production because of the drawbacks in the use of fossil fuels, namely the rapid-depletion of such fuels, the increase in price, the global warming produced by them, and the pollution of the environment resulting from their use.

There are many advantages in using large wind turbines of large rotor diameter and output power, than smaller turbines. These advantages include more power output per unit cost, lower fixed costs associated with installation and maintenance per power unit output, and greater availability of suitable land sites, e.g., where optimum wind conditions exist, even though not as accessible as other land sites.

However, large wind turbines have a number of disadvantages limiting their use. One important disadvantage is the turbine weight, since the rotor cost, which is about 15% of the total cost for its weight, increases approximately with the cube of the rotor diameter, whereas the energy harnessed increases with the square of the rotor diameter. This disproportionate increase in rotor weight also causes increases in the tower, foundation, and installation costs, particularly since special cranes, special transportation facilities, etc., may also be required.

Many developments have been made to overcome the problems associated with an increase in the rotor size, as indicated by U.S. Pat. Nos. 6,749,399, 5,642,984, 6,100,600, 5,876,181, 5,182,458 and 5,146,096, all proposing the use of multi-rotor arrays in order to replace giant single rotor systems. U.S. Pat. No. 6,749,399, for example, discloses a wind turbine system with an array of rotors arranged at various heights, each rotor being optimized for the height at which it is located. U.S. Pat. No. 5,642,984 discloses a wind turbine system including an array of helical turbine units or modules arranged vertically or horizontally. The systems proposed by the above two patents, together with their limitations, will be described more particularly below.

### OBJECTS AND BRIEF SUMMARY OF THE PRESENT INVENTION

One object of the present invention is to provide a wind turbine system constituted of a plurality of modular wind turbine units having advantages in one or more of the above respects. Another object of the invention is to provide a modular wind turbine particularly useful in such systems.

According to one aspect of the present invention, there is provided a wind turbine system comprising a two-dimensional array of a plurality of modular wind turbine units arranged in a plurality of horizontal rows and vertical columns; the two-dimensional array of modular wind turbine units being carried by a frame structure including a plurality of parallel beams extending along a first orthogonal axis and spaced from each other along a second orthogonal axis, with the plurality of modular wind turbine units mounted between each pair of the parallel beams extending along the first orthogonal axis.

In the preferred embodiment of the invention described below, the plurality of parallel beams extend horizontally in the frame structure and are spaced vertically in the frame structure. The frame structure comprises a plurality of sections, each section including a plurality of horizontally-extending, vertically-spaced beams, and a plurality of modular wind turbine units mounted between each pair of the horizontally-extending beams in each section to define said two-dimensional array.

According to further features in the described preferred embodiment, the plurality of parallel beams, with the plurality of modular wind turbine units mounted between them in the two-dimensional array, are rotatably mounted about a central vertical axis to enable changes in the yaw of the modular wind turbine units to be made with respect to the central vertical axis. The frame structure further comprises a central supporting tower; a main horizontal beam rotatably mounted to the central supporting tower and carrying the plurality of parallel beams and the plurality of modular wind turbine units mounted between them in the two-dimensional array; and a plurality of supporting legs having their upper ends fixed to the main horizontal beam, and their lower ends carrying roller elements rotatably supporting the main supporting beam, including a two-dimensional array of modular wind turbine units supported thereon, so as to be rotatable with respect to the central supporting tower.

According to another aspect of the present invention, there is provided a modular wind turbine unit particularly for use the above-described wind turbine system, comprising: a common frame; a first plurality of blades fixed to a first central shaft mounted within the common frame; a second plurality of blades fixed to a second central shaft mounted within the common frame, with the second central shaft coupled in an end-to-end relation to the first central shaft; and an electrical generator coupled to one end of the coupled first and second shafts to be rotated thereby.

As will be described more particularly below, such a wind turbine system, and also the modular wind turbine unit included in such system, provides many of the advantages of both a large wind turbine system and also of a smaller wind turbine system, without many of their respective disadvantages.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates prior art wind turbine system constructed according to the above-cited U.S. Pat. No. 6,749,399;

FIG. 2 illustrates a prior art wind turbine system constructed in accordance with the above-cited U.S. Pat. No. 5,642,984;

FIG. 3 is a plan view schematically illustrating a wind turbine system constructed in accordance with the present invention;

FIG. 4 illustrates a rotor sub-unit in a modular wind-turbine unit constructed in accordance with the present invention;

FIG. 5 illustrates a modular wind-turbine unit constructed in accordance with the present invention including a plurality of the rotor sub-unit of FIG. 4;

FIG. 6 more particularly illustrates the flexible coupling between two rotary shafts in the modular wind turbine unit of FIG. 5;

FIG. 7 more particularly illustrates the lower end of the modular wind turbine unit of FIG. 5;

FIG. 8 illustrates a wind turbine system constructed in accordance with the present invention to include a large number, e.g. 200, of modular wind turbine units illustrated in FIG. 5;

FIG. 9 is a sectional view along line IX-IX of FIG. 8, to more particularly illustrate the skywalk provided for each of the horizontal beams in the wind turbine system of FIG. 8;

FIG. 10 is a sectional view along line X-X of FIG. 8 to more particularly illustrate the guy-wire bracing arrangement provided in the wind turbine system of FIG. 8;

FIG. 11 schematically illustrates the first step, namely laying down the foundation, in the erection of a wind turbine system constructed in accordance with FIG. 8;

FIG. 12 schematically illustrates a next step in the erection of the wind turbine system of FIG. 8;

FIG. 13 schematically illustrates the following step in the erection of a wind turbine system according to FIG. 8;

FIG. 14 illustrates a self-lifting crane which may be used in erecting the wind turbine system of FIG. 8;

FIG. 15 illustrates one manner of scaling-up the power output of a previously-erected wind turbine system according to FIG. 8; and

FIG. 16 schematically illustrates the erection of a wind turbine system on a floating raft, to enable harnessing wind energy over water bodies.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF RELEVANT PRIOR ART

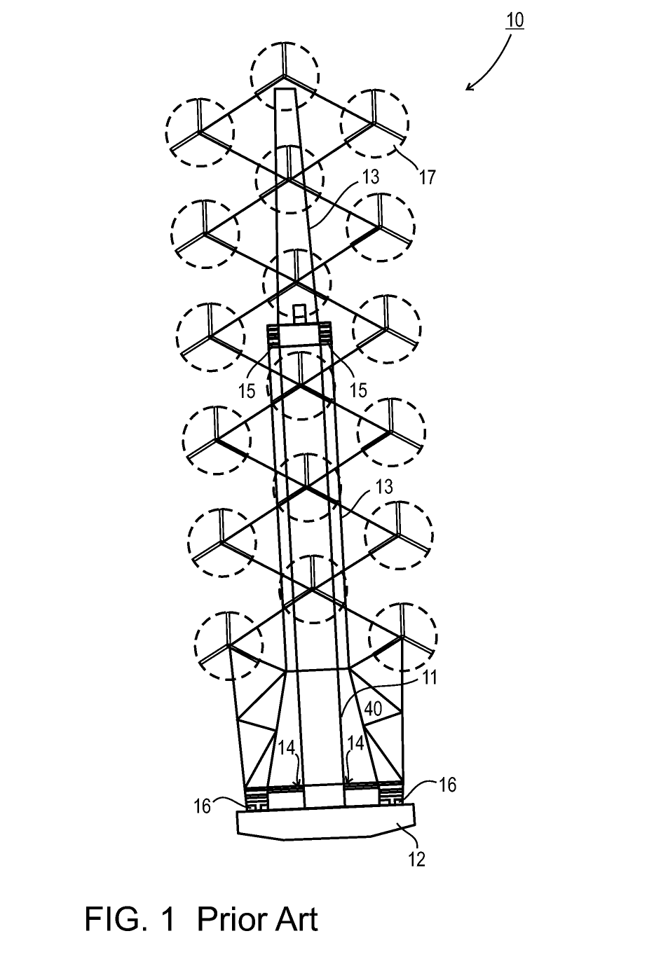

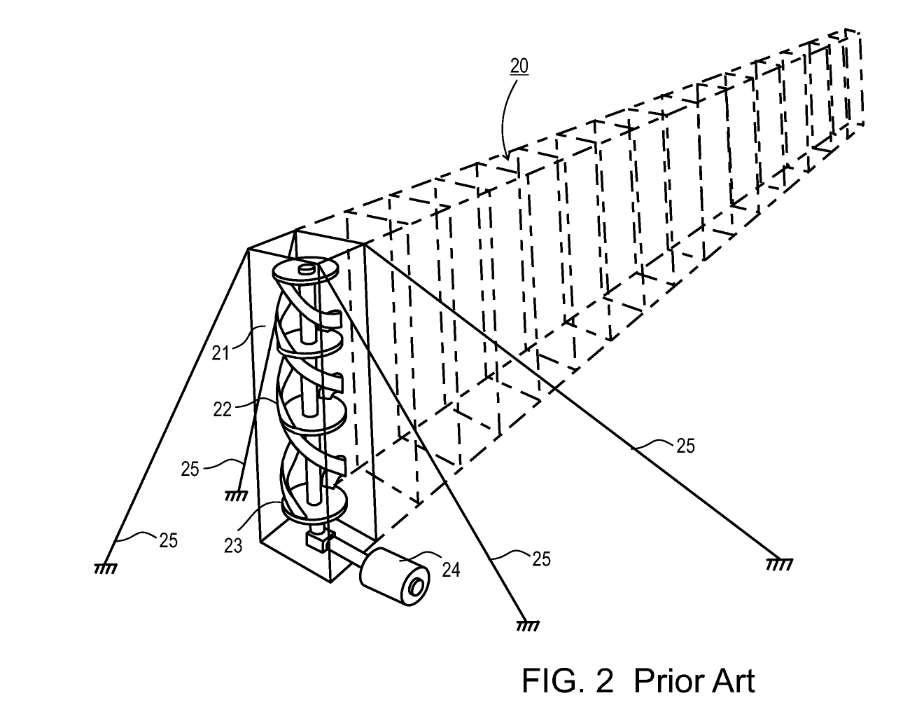

As indicated above, there have been many proposals to construct wind turbine systems of high power outputs in the form of arrays of a plurality of modular wind turbine units in order to obtain the benefits of large-rotor wind turbine systems without many of the disadvantages. FIGS. 1 and 2 illustrate two such prior-art systems.

The system illustrated in FIG. 1 is that described in U.S. Pat. No. 6,749,399. Basically, the illustrated system, generally designated 10, includes a central tower structure comprised of a lower pole 11 fixed to a foundation 12, and an upper power structure 13 rotatably mounted to the lower pole 11 by a pair of bearings 14, 15, the vertical components of a load being transmitted to the foundation 12 by bogies 16. The tower structure carries a plurality of wind turbines 17 at various heights, with the rotor for each turbine being optimized according to the height at which it is located. Each of the wind turbine units 17 in the illustrated system is of the horizontal axis type, e.g. mounting a plurality of propellers for rotation about the horizontal axis.

Such a system thus provides yaw control with respect to the wind direction. However, horizontal-axis wind turbines should align their rotor surfaces perpendicularly to the incoming wind direction. The performance of such a turbine is reduced if some misalignment occurs. Such misalignment also produces undesirable cyclic loads. Moreover, if the wind speed exceeds a very high level (e.g., hurricane level), the turbine system is yawed “out of the wind”.

Moreover, in this type of system, independent yawing for each rotor would increase its efficiency. However, such independent yawing not only increases the cost of the system, but also tends to produce large gaps between two adjacent rotors in order to avoid flooding of one rotor with the wake of the other, thereby reducing the efficiency of the overall system.

A further important aspect in the construction of such a system is the selection of the natural frequencies of the construction members, and verification of their compatibility to the modal characteristics of the rotating rotators. For example, if the rotors rotate at 0.5 Hz (30 rpm) the natural frequency of the construction should be much below or much above this value. The “much below” (soft construction) is possible, but requires complicated design. The “much above” requires additional stiffening of the construction, which again increases the weight and cost of the system.

Further, the high costs required for such turbine systems including horizontal-axis rotors substantially prevent the use of systems in “offshore” locations.

If, however, a central yaw control is effected with respect to the tower, field experiments show that the stability of the incoming wind in the yaw axis is reduced as the exponent of the power increases, and as the average wind speed increases. The result is a reduction in productivity and an increase of loads and vibration.

The preferred embodiment of the present invention uses a different type of rotor, which is less sensitive to the yaw position, to turbulence, and to wind shear. The rotor can be designed to rotate fast enough to ensure sufficient frequency band for the construction, but not too fast in order to avoid vibration due to the rotation itself. The aerodynamic efficiency of the rotor design is sufficiently high (close to the horizontal axis rotor efficiency) to avoid a decrease in the energy capture, and thereby an increase in the price per unit of energy production.

The prior art construction illustrated in FIG. 2 is that described in U.S. Pat. No. 5,642,984. That patent, as well as U.S. Pat. Nos. 6,036,443 and 6,155,892, proposed an array of vertical-axis wind turbines, in which each module includes a rotor having a helical blade and also includes its own generator.

Thus, as shown in FIG. 2, such a wind turbine system, generally designated 20, includes a plurality of modules 21, each including a helical blade 22 fixed to a central shaft 23 coupled to a generator 24 for producing an electrical output corresponding to the rotation of the shaft by the wind impinging the helical blade 22. The modules are arranged in a side-by-side relationship and are braced by a plurality of guy-wires 25, to provide a “wall” of turbine modules.

However, such a system has a number of disadvantages, particularly when used in low wind speed sites.

Thus, such wind turbine systems, when used in low wind speed sites, require tall towers in order to increase the energy capture, which will result in increased construction and installation costs. In addition, even where the site has almost unidirectional upcoming wind, in order to increase the probability to have the wind direction approximately 90 degrees to the turbines, that two rotor diameters should be taken as a gap between module and the adjacent one. This means that the real length of the module along the “wall” of turbines is about three rotor diameters. Moreover, such an arrangement is not optimal for productivity since in most of the sites, shading will reduce the productivity. While the productivity could be increased by arranging the modules in staggered rows and with sufficient distances between each other (as wind farms are regularly arranged), the total cost of the “walls” is the sum of the turbine costs.

Wind turbines systems constructed in accordance with the present invention, as described more particularly below, provide a number of advantages over such prior art constructions in one or more of the above respects.

### DESCRIPTION OF A PREFERRED EMBODIMENT OF THE PRESENT INVENTION

Briefly, the present invention provides a wind turbine system comprising a two-dimensional array of a plurality of modular wind turbine units arranged in a plurality of horizontal rows and vertical columns. Each of the modular wind turbine units includes a modular frame and a plurality of rotor sub-units mounted within the modular frame and secured together to rotate a common rotary shaft. In the described preferred embodiments, each of the modular wind turbine units includes two pluralities of rotor sub-units, each plurality being secured to a single shaft, with the two shafts being coupled together in an end-to-end relation by a flexible coupling to accommodate misalignment of the two rotary shafts.

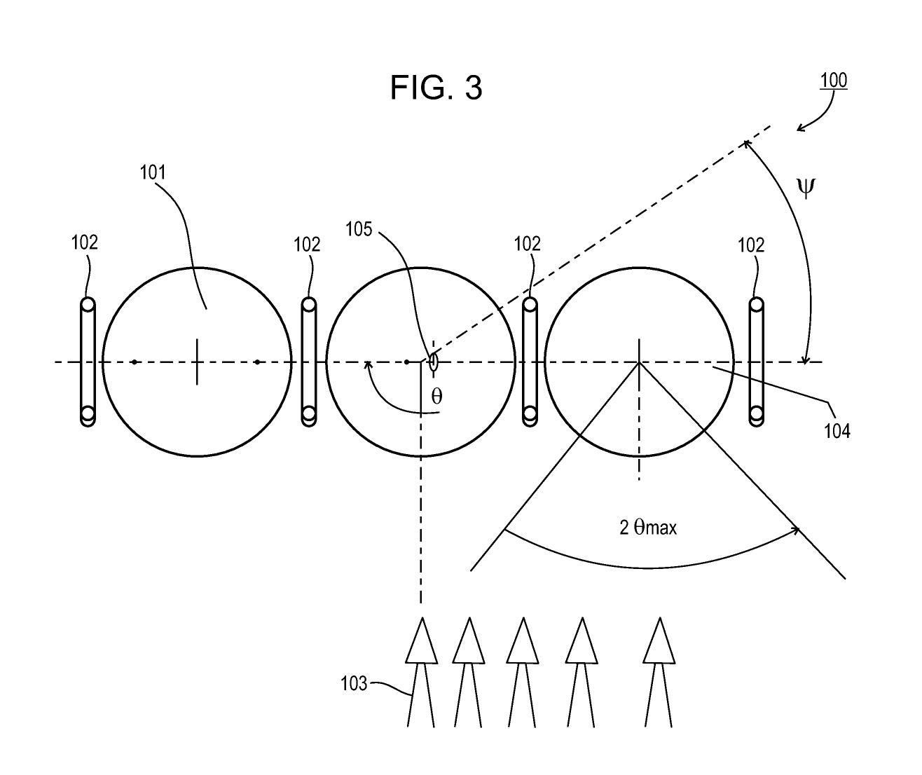

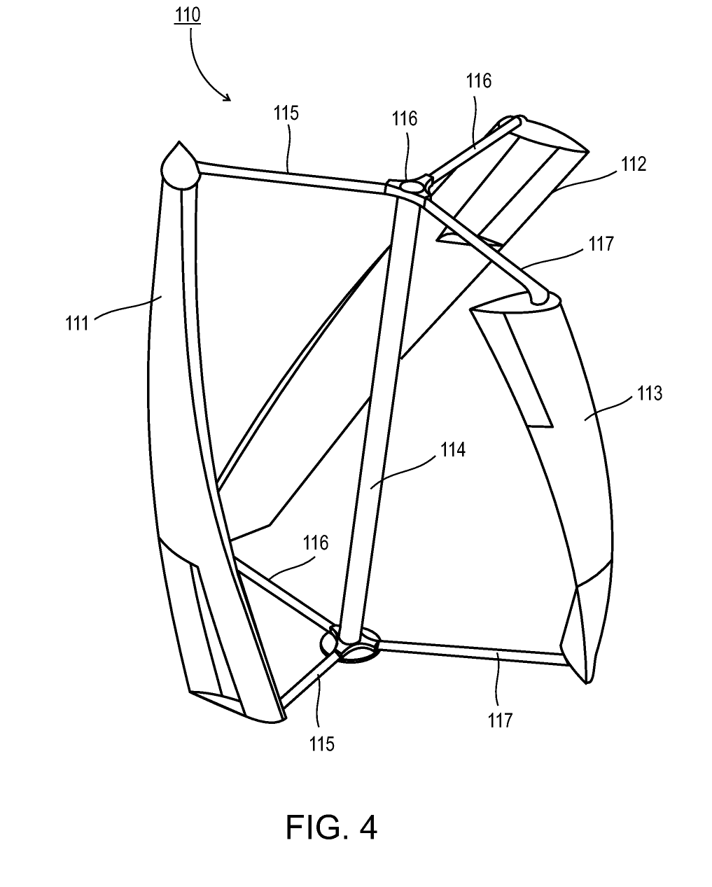

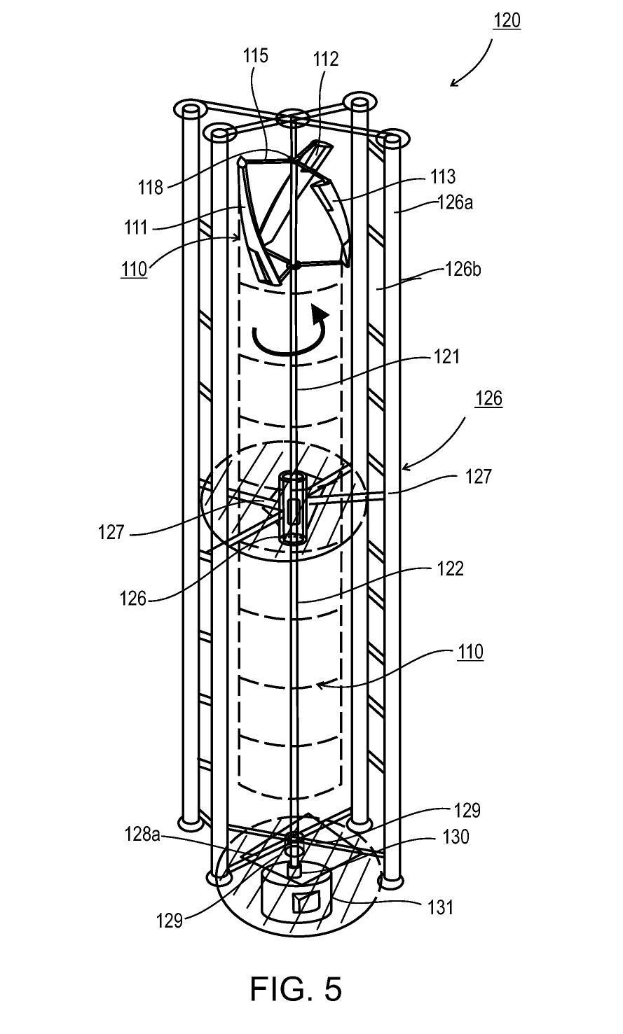

FIG. 3 is a schematical top view of a wind turbine system, generally designated 100, constructed in accordance with the invention including, for purposes of example, three modular wind turbine units 101 mounted within a frame structure 102. Each modular wind turbine unit 101 may be of the construction illustrated in FIG. 5, to be described below, with each such unit including a plurality of rotor sub-units, as described below with respect to FIG. 4. The angle between the upcoming wind direction 103 and the swept surface 104 is indicated as Θ. The maximum permitted upcoming wind angle (without mutual shading) is defined as 2 Θₘₐₓ. The entire line of modular wind turbine units can be yawed in the indicated yaw angle Φ around the central pivot 105.

FIG. 4 illustrates the construction of each rotor sub-unit included in each of the modular wind turbine units 101, having the structure illustrated in FIG. 5 as described below. As shown in FIG. 4, each rotor sub-unit 110 includes three helical blades 111-113, fixed to a central vertical shaft 114 by three pairs of radial arms, 115-117 secured to the opposite ends of each of the helical blades. The opposite ends of the three helical blades are secured by the three pairs of arms 115-117 such that the blades are circumferentially spaced from each other and are radially spaced from the central shaft 114. Preferably, the helical blades 111-113 are constructed as described in PCT Application IL2008/001567 filed Dec. 4, 2008, assigned to the same assignee as the present application, i.e. with each blade “twisted” so that its lower attachment point is displaced angularly relative to its upper attachment point such that the helix extends in the opposite direction to the direction of rotation of the turbine blade about its vertical rotary axis, the bottom of the blade thus leads its top during the rotation of the blade.

The rotor sub-unit 110 illustrated in FIG. 4 further includes a hub connection 118 for attaching the vertical rotary shaft 114 to another rotor sub-unit, as will be described more particularly below with respect to FIG. 5. Hub 118 is welded to the vertical shaft 114, and the latter shaft is preferably made from a hollow steel cylinder or from a seamless steel pipe for weight reduction.

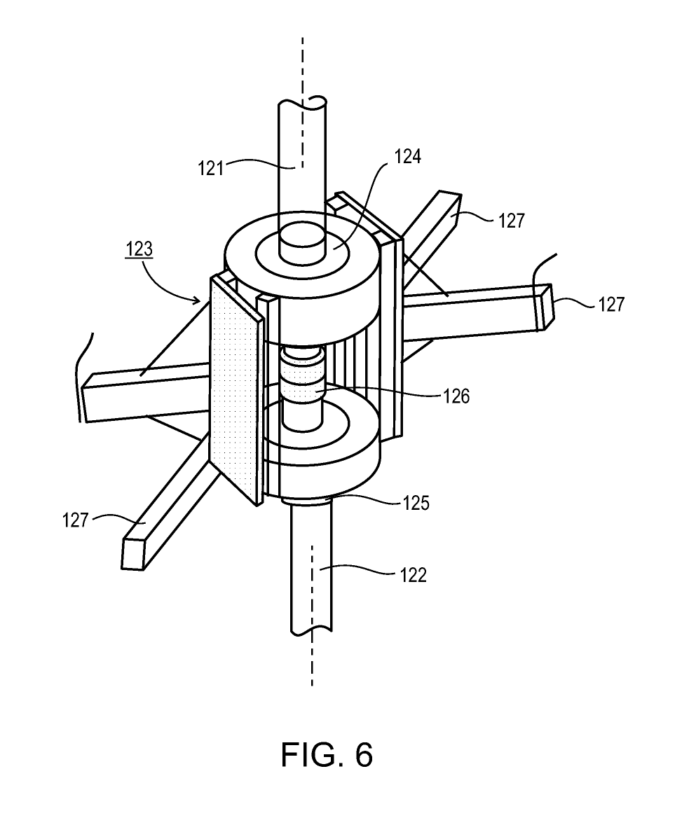

FIG. 5 illustrates a complete modular wind turbine unit, therein generally designated 120, constructed of a plurality of rotor sub-units 110 of FIG. 4. In the example illustrated in FIG. 5, the modular wind turbine unit 120 includes 10 rotor sub-units 110 with their vertical shafts 114 secured together in an end-to-end relation via their hubs 118 to define a single vertical rotary shaft for the modular wind turbine unit. In the illustrated example, the vertical length of the central vertical shaft, constituted of the joined vertical shafts of the 10 rotor sub-units 110, may be approximately 11 meters. For this reason, the illustrated modular wind turbine unit 120 is constituted of two assemblies of rotor sub-units, namely an upper assembly including an upper vertical rotary shaft 121, and a lower assembly including a lower vertical rotary shaft 122. In addition, the two vertical shafts 121, 122 are joined together in an end-to-end relation by a flexible coupling 123, more particularly illustrated in FIG. 6.

Thus, as shown in FIG. 6, the two vertical shafts 121, 122, each having a typical length of 5.5 meters, and are coupled together by the previously-mentioned flexible coupling 123. The latter coupling includes two end bearings 124, 125 engaging the respective ends of the two vertical shafts 121, 122, with a flexible coupling member 126 in between.

The modular wind turbine 120 illustrated in FIG. 5 further includes a modular frame 126, constituted of a plurality of vertical tubes 126a connected together by a plurality of connection plates 126b to define an enclosure for all the rotor sub-units 110 in the respective module. The flexible coupling 126 coupling the ends of the top and bottom vertical shafts 121, 122 also includes a plurality of radial arms 127 connected to tubes 126a of the module frame 126.

The bottom central shaft 122 is supported on a bottom bearing 128. Bearing 128, as well as bearing 123 joining the confronting ends of the two vertical shafts 121, 122, are preferably self-aligned ball-bearings to eliminate the need of accurate production of the module frame 126 as well as of the two vertical shafts 121, 122.

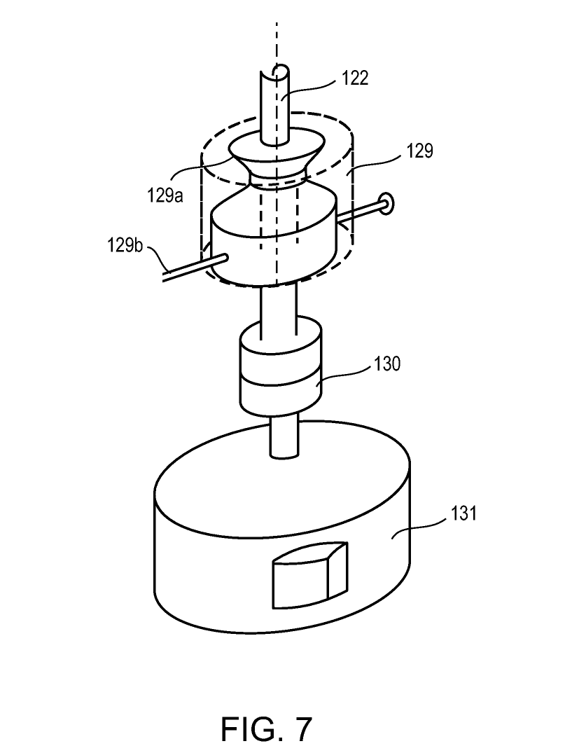

As further seen in FIG. 5, and more particularly in FIG. 7, the lower end of the bottom vertical shaft 122 is coupled to a brake assembly 129, including a centrifugal brake 129a and an electromagnetic brake 129b for controlling the rotation of the central vertical shafts 121, 122. Brake assembly 129 is in turn coupled by flexible coupling 130 to a generator 131 for generating electrical energy by the rotation of the vertical shafts in the respective modular wind turbine unit 120 illustrated in FIG. 5.

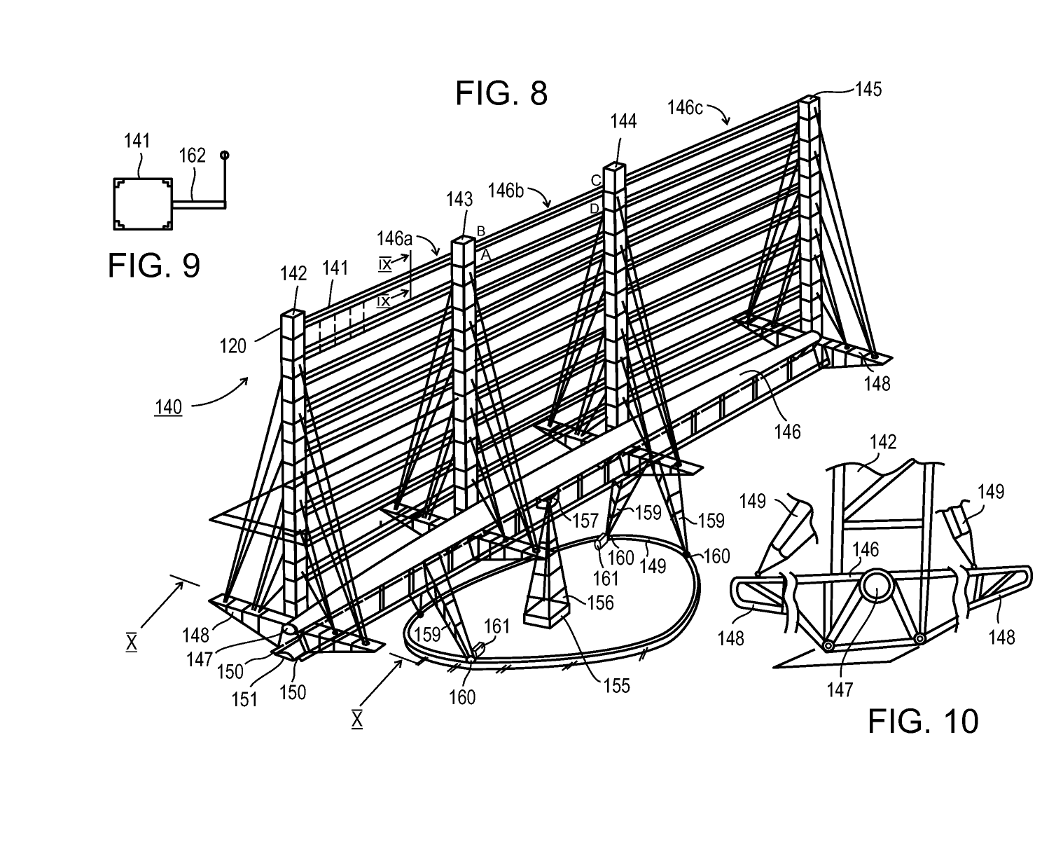

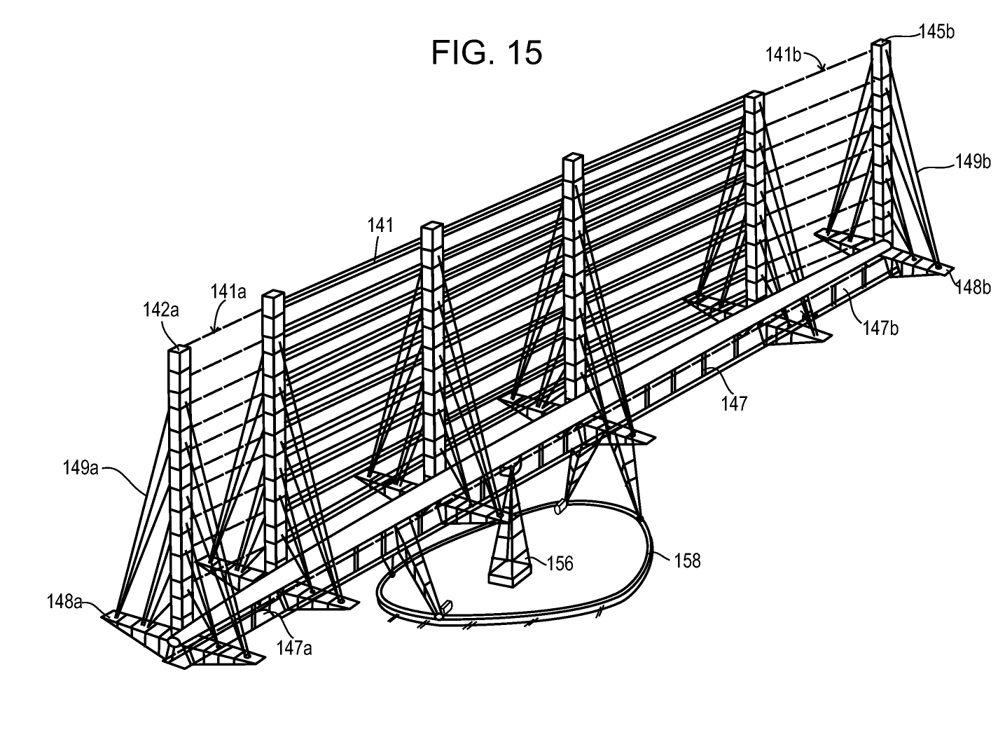

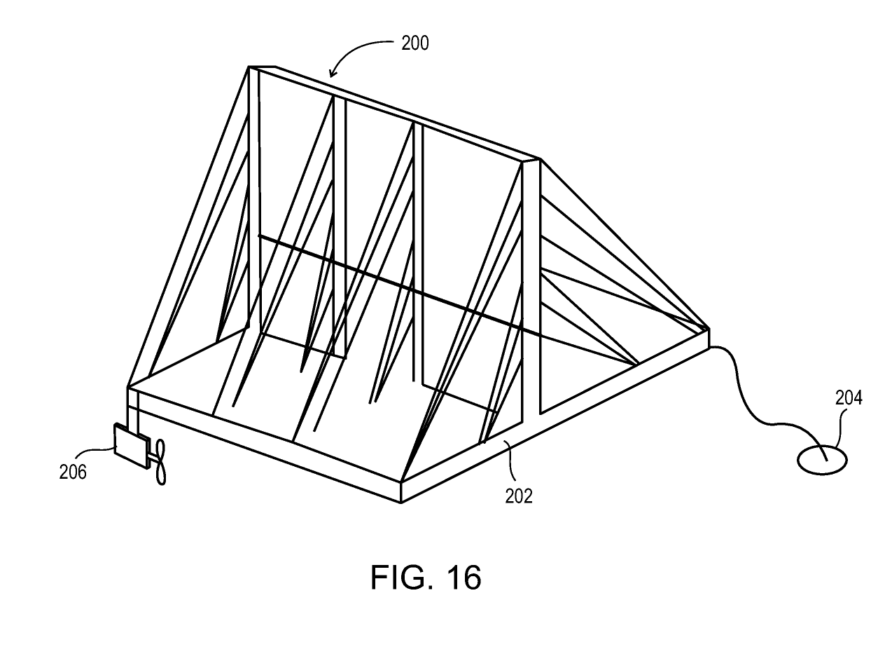

FIG. 8 illustrates an example of a complete modular wind turbine system constructed in accordance with the present invention, to include a number of the modular units 120, in this case 300 such units, each constructed as shown in FIG. 5. As will be described more particularly below with respect to FIG. 15, such a modular system can even be upgraded, whenever desired, to include additional modular units; an additional 220 units is shown in the example of FIG. 15. thereby totaling 500 modular units.

As shown in FIG. 8, the modular system illustrated in FIG. 6 includes a two-dimensional frame structure 140 comprising a plurality of parallel beams 141 extending along a first orthogonal axis (in this case along the horizontal axis), and spaced from each other along a second orthogonal axis (in this case the vertical axis). In the example illustrated in FIG. 8, there are 10 such horizontal beams 141 vertically spaced from each other. The vertical height is about 11 meters, the height of each of the modular wind turbine units 120 illustrated in FIG. 5.

The 10 horizontal beams 141 are supported by four vertical towers 142-145, dividing the two-dimensional array of beams into three equally-dimensioned sections 146a, 146b and 146c. The horizontal beams 141 thus define a two-dimensional array of support for receiving a large number of the modular wind turbine units of FIG. 5, shown schematically by broken lines 120 in FIG. 8. In the illustrated example, each of the three sections 146a-146c includes ten rows of such modular units 120, with ten units in each row, thereby totaling 100 units for each section, or a total 300 for the three sections. Such a system is capable of generating approximately three MW of electricity.

The frame structure 140 of the modular wind turbine system of FIG. 8 further includes a main supporting horizontal beam 146 to which the lower ends of the four vertical towers 141-145 are secured. As shown particularly in FIG. 10, the main horizontal supporting beam 146 is supported on a tubular member 147 and includes transversely-extending plates 148 at each of the locations of the four towers 142-145. Guy-wires are secured between the upper end of each of the four towers to the transverse plates 148 in order to brace the system.

The lower horizontal beam 146 carries the main portion of the system load. These loads are mainly torsion loads, and also additional bending loads. Tubular member 147 underlying the main horizontal beam 146, which may have a typical diameter of 1.0 meter, carries the torsion loads. The total section modulus for bending is increased by four angular beams 150 joining tubular member 147 to an underlying horizontal plate 151, and two further tubular members 152 and 153 at the junctures of angular members 150 to the outer edges of the underlying horizontal plate 151.

The foregoing frame structure 140 including the ten horizontal beams 141, the lower horizontal beam 146, and the four vertical towers 142-145 supported by the latter beams, is supported over a foundation member by a central tower 156 fixed at its lower end to foundation member 155, and connected to the lower horizontal beam 146 by a pivot bearing 157. Foundation member 155 includes a circular track 158, and the main horizontal beam 146 is supported over the foundation by four legs 159 each provided with a wheel 160 at its lower end movable along track 158. Foundation 155 further includes one or more electrical motors 161 (two being shown in FIG. 8) coupled to the wheels 160 for rotating the frame assembly about the central tower 156.

As described above, the space between adjacent horizontal supporting beams 141, as indicated by the rectangular space defined by the letters A-D in the center section 146b of the frame assembly, is used for mounting the modular wind turbine units 120, as indicated by the dotted lines in FIG. 8 between the two upper horizontal beams 141. Each of the modular wind turbine units 120 is of the construction illustrated in FIG. 5, and, as indicated above, the frame structure illustrated in FIG. 8 accommodates 100 of such modular wind turbine units in each section 146a-146c, or a total of 300 modular tubular units. Each horizontal beam 141 is provided with a special skywalk 162 (FIG. 9) to enable access to each modular wind turbine unit 120 for maintenance or repair.

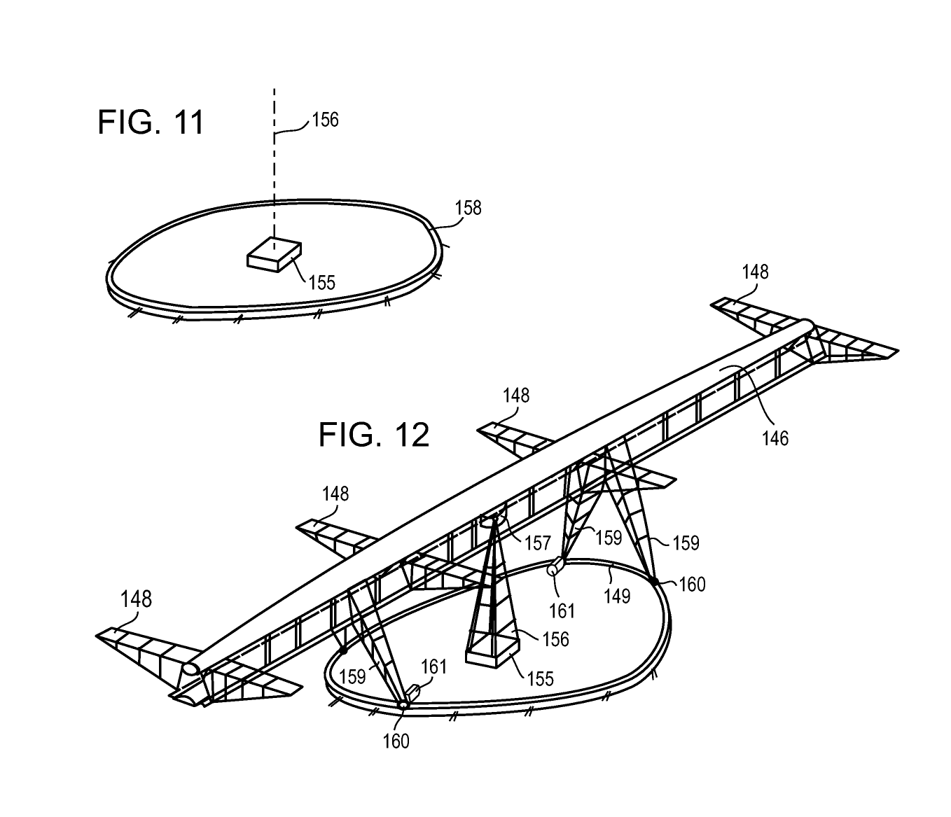

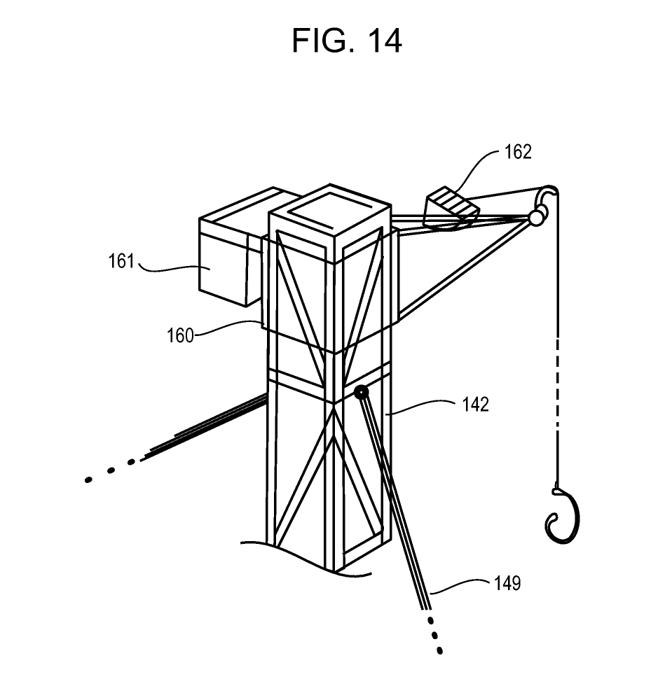

As indicated earlier, the frame assembly 140 of the horizontal beams 141 between the vertical towers 142-145 provides rectangular spaces (e.g. defined by space A-D in the center section 146) having typical dimensions of 12 meters in height AB, and 30 meters in length BC in the three MW example illustrated for accommodating 300 modular wind turbine units 120, with each unit producing an output of ten Kw. The total weight of the entire assembly, in this example, is less than 130 tons of steel, which is about one-third the total weight of a conventional wind turbine (propeller type) design for low wind-speed sites and having the same rated power. Such an installation could be effected by using simple construction tools and self-erection techniques. This is illustrated, for example, in FIGS. 11-13, which illustrate the various steps in the erection of such an installation, and in FIG. 14 which illustrates a self-erecting, self-climbing crane which can be used in the erection procedure in cooperation with the central tower 156.

Thus, FIG. 11 illustrates the first step in the erection procedure, wherein a foundation 155 is provided for the central tower 156, and a circular rail 158 is laid around this foundation.

Next, as seen in FIG. 12, the tower 156 is erected on foundation 155, the flexible coupling 157 is provided at the upper end of the tower, and the main horizontal beam is then mounted to the upper end the tower and coupled thereto by flexible coupling 157 to permit rotation of beam 146 with respect to the tower. The main horizontal beam 146 is provided with the four legs 159 each carrying, at its lower end, a wheel 160 receivable within the circular track 158. The main horizontal beam 146 is also provided with the four transversely-extending plates 147 for attachment of the guy-wires 149 (FIG. 8). The construction work to this stage is performed at a lower height than 30 meters, and thus does not require any unique cranes.

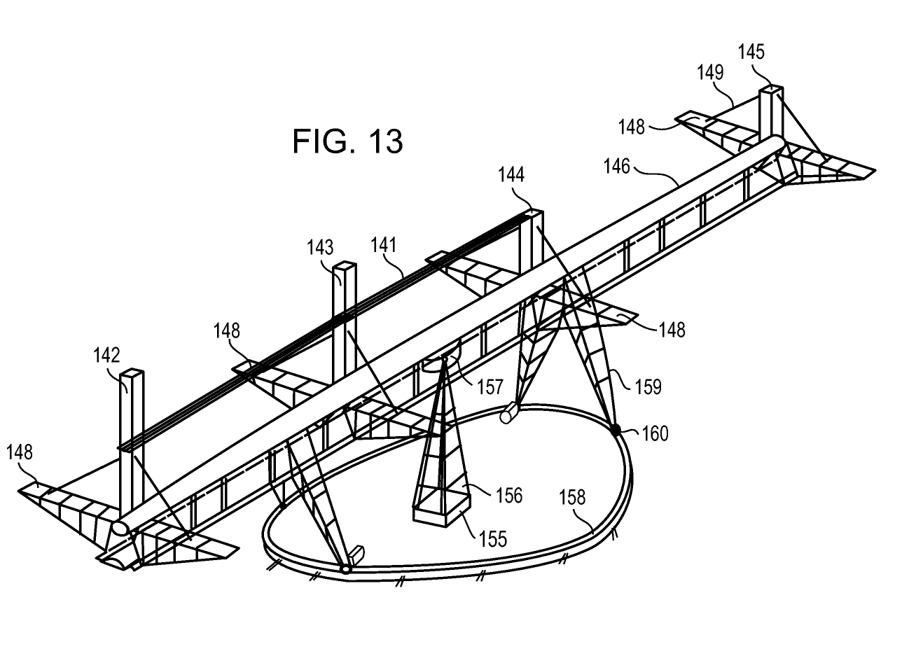

FIG. 13 illustrates the step wherein the four vertical towers 142-145 are fixed to the bottom horizontal plate 146 and braced by guy wires 149 attached to the transversely-extending anchoring beams 148. Each of the horizontal beams 141 may then be assembled and fixed to the vertical towers 142-145, starting with the lowermost horizontal beam. This stage does not require any external lifting devices or special cranes, as the vertical towers 142-145 can be used as the vertical support for self-erecting cranes, such as shown in FIG. 14.

Thus, as seen in FIG. 14, vertical tower 142 receives the crane 160 which has the capability of sliding upwardly, but not downwardly because of the guy wires 149. Crane 160 has a counter-weight 161, and a simple winch mechanism 162 effective to lift the respective crane 161 with respect to its vertical tower 160.

It will be seen that two such cranes 160 assembled on adjacent towers, e.g. towers 142 and 143, can lift together each of the horizontal beams 141 for attachment to the towers, and can also lift each pre-assembled modular wind turbine unit 120 to its respective location in the spaces between two horizontal beams, as described above. If desired, each crane can be left at the top of its respective tower 142-145 for future maintenance and part replacement, or can be disassembled at its upper position and lowered to ground level.

FIG. 15 illustrates the scalability characteristics of the wind turbine system described above, by demonstrating the optional upgrading of the 3 MW to a 5 MW system. For this purpose, another set of 200 modular wind turbine units 120 may be added to the existing 300 modular wind turbine units 120 as described above. For this purpose, this upgrading is performed by installing an extension 147a, 147b at each of the opposite ends of the horizontal supporting beam 147, two additional vertical towers 142a, 145a at the opposite ends of the frame structure 140 including the towers 142-145, and two sets of horizontal beam extensions 141a, 141b between the additional towers 142a, 145a and the initial towers 142 and 145. For this purpose, vertical towers 142a and 145a, in cooperation with the ends of their respective adjacent original vertical towers 142, 145, may be used in a self-erecting crane arrangement, such as described above with respect to FIG. 14, for attaching the horizontal beam extensions 141a and 141b, as well as for introducing the modular wind turbine units 120 into the spaces defined between two such horizontal beam extensions.

After the upgraded wind turbine as illustrated in FIG. 15 has been assembled, the additional guy wires 149a, 149b may be applied between the transverse anchoring beams 148a, 148b fixed to the lower horizontal beam extensions, 147a, 147b and the upper ends of the newly-added vertical towers 142a, 145a, for bracing the upgraded system.

In all other respects, the upgraded system illustrated in FIG. 15 is constructed and assembled as described above with respect to FIGS. 3-14, and therefore to facilitate understanding, the same reference numerals are used for identifying corresponding parts. To increase stability, however, an additional circular rail (not shown) may be provided outwardly of, and concentric to, rail 158, together with an additional group of support legs (corresponding to legs 159), carrying wheels at their lower ends (corresponding to wheels 160) rollable along this additional rail.

Another advantage of the present invention is illustrated in FIG. 16. Thus, most of the offshore turbine installations are currently situated in shallow water (up to 50 meters depth). The sites associated with such water depths are mainly close to the seashore and are located near harbors and naval transportation lanes. When so located, they may interface the normal activities of such harbors. The windier, less interfering, sites are mainly located in deep-water locations (up to 300 meters depth of sea). Unlike the shallow water installations, where the turbine foundation is based on the sea grounds, the deep-water installation requires a floating raft. The stability of the yaw axis is a very dominant parameter, as a sophisticated and expensive mooring device is required to eliminate the yaw movements of the raft, while the horizontal axis wind turbine yaws to the other direction.

FIG. 16 illustrates a novel wind turbine system constructed in accordance with the present invention, and therein generally designated 200, as being mounted on a floating raft 202. The required mooring is a simple mono-guy mooring 204, typical for ships. The yaw can be provided by a small water-borne motorized propeller 206, which can supply the desired yaw positioning of the wind turbine system with respect to the wind direction.

While the invention has been described with respect to several preferred embodiments, it will be appreciated that these are set forth merely for purposes of example, and that many other variations, modifications and applications of the invention may be made.

1. A wind turbine system comprising:
a two-dimensional array of a plurality of modular wind turbine units arranged in a plurality of horizontal rows and vertical columns;
characterized in that said two-dimensional array of modular wind turbine units is carried by a frame structure including a plurality of pairs of parallel horizontal beams extending along the horizontal axis and spaced from each other along the vertical axis, and that each of said plurality of modular wind turbine units rotating around a vertical axis mounted between each pair of the parallel beams extending along said horizontal axis.

2. (canceled)

3. The system according to claim 1, wherein said frame structure comprises a plurality of sections, each section including a said plurality of horizontally-extending, vertically-spaced beams, and a said plurality of modular wind turbine units mounted between each pair of said horizontally-extending beams in each section to define said two-dimensional array.

4. The system according to claim 1, wherein said plurality of parallel beams, with said plurality of modular wind turbine units mounted between them in said two-dimensional array, are rotatably mounted about a central vertical axis to enable changes in the yaw of the modular wind turbine units to be made with respect to said central vertical axis.

5. The system according to claim 4, wherein said frame structure further comprises:
a central supporting tower fixed on a supporting base;
a main horizontal beam rotatably mounted to said central supporting tower and carrying said plurality of parallel beams and said plurality of modular wind turbine units mounted between them in said two-dimensional array;
and a plurality of supporting legs having their upper ends fixed to said main horizontal beam, and their lower ends carrying roller elements rotatably supporting the main supporting beam, including a two-dimensional array of modular wind turbine units supported thereon, so as to be rotatable with respect to said central supporting tower.

6. The system according to claim 5, wherein at least one of said roller elements rotatably supporting said main horizontal beam is coupled to a drive motor for driving the main horizontal beam and the two-dimensional array of modular wind turbine units carried thereby in a circular path.

7. The system according to claim 5, wherein said system includes a circular track around said fixed tower, and said roller elements on the lower ends of said supporting legs are wheels rollable along said track.

8. The system according to claim 5, wherein said main horizontal beam is divided into a plurality of sections, each section including a two-dimensional array of modular wind turbine units.

9. The system according to claim 5, wherein said main horizontal beam includes transversely-extending guy-wire plates at its opposite ends for receiving a plurality of guy-wires to brace said frame structure with said two-dimensional array of modular wind turbine units carried thereby.

10. The system according to claim 1, wherein each of said modular wind turbine units includes at least one rotor sub-unit and an electrical generator driven by said rotor sub-unit.

11. The system according to claim 1, wherein each of said modular wind turbine units includes a modular frame and a plurality of rotor sub-units mounted within said modular frame and secured together to rotate a common rotary shaft; and wherein said electrical generator is driven by said common rotary shaft.

12. The system according to claim 11, wherein each of said rotor sub-units in each of said modular wind turbine units includes a plurality of helical blades mounted to a said rotatable shaft by mounting arms at the opposite ends of each helical blade, such that the helical blades are circumferentially spaced from each other and are radially spaced from said rotary shaft.

13. The system according to claim 1, wherein each modular wind turbine unit includes a first plurality of rotor sub-units each having a first plurality of blades mounted on a first rotary shaft, and a second plurality of rotor sub-units each having a second plurality of blades mounted on a second rotary shaft;
and wherein the first and second rotary shafts are coupled in end-to-end relation by a flexible coupling to accommodate misalignment of the rotary shafts.

14. The system according to claim 13, wherein said first and second pluralities of rotor sub-units in each modular wind turbine unit are enclosed within a common frame;
and wherein the first and second rotary shafts of each modular wind turbine unit are mounted for rotation about a central vertical axis and are coupled at one end to an electrical generator.

15. The system according to claim 14, wherein said one end of said coupled first and second rotary shafts of each of said modular wind turbine unit includes a brake.

16. The system according to claim 1, wherein said two-dimensional array of a plurality of modular wind turbine units are mounted on a floating structure for use over water.

17. A modular wind turbine unit particularly for use in a wind turbine system according to claim 1, comprising:
a common frame;
a first plurality of blades fixed to a first central shaft mounted within said common frame;
a second plurality of blades fixed to a second central shaft mounted within said common frame, with the second central shaft coupled in an end-to-end relation to said first central shaft;
and an electrical generator coupled to one end of said coupled first and second shafts to be rotated thereby.

18. The modular wind turbine unit according to claim 17, wherein said first and second central shafts are coupled together in said end-to-end relation via a flexible coupling to accommodate misalignment of the two rotary shafts.

19. The modular wind turbine unit according to claim 17, wherein said first plurality of blades are part of a first plurality of said rotor sub-units coupled to said first central shaft;
and wherein said second plurality of blades are part of a second plurality of rotor sub-units coupled to said second central shaft.

20. The modular wind turbine unit according to claim 19, wherein each of said rotor sub-units includes a plurality of helical blades mounted to a said rotary shaft by mounting arms at the opposite ends of each helical blade such that the helical blades are circumferentially spaced from each other and are radially spaced from said rotary shaft.
